(19) United States
(12) Patent Application Publication
(10) Pub. No.: US 2007/0184181 A1
(43) Pub. Date: Aug. 9, 2007

(54) Device and method for forming film for organic electro-luminescence element using inductive coupling CVD

(76) Inventor: Kazuo Wada, Kyotoshi (JP)

Correspondence Address: WAGNER, MURABITO & HAO LLP, Two North Market Street, Third Floor, San Jose, CA, 95113, US

(21) Appl. No.: 10/949,259

(22) Filed: Sep. 24, 2004

Related U.S. Application Data
(63) Continuation of application No. PCT/JP03/03636, filed on Mar. 25, 2003.

(51) Int. Cl. B05D 5/06

(52) U.S. Cl. 427/69

(57) ABSTRACT

A method for forming an electro-luminescence device, in accordance with one embodiment of the present invention, includes forming a high polymer film on an electro-luminescence panel utilizing an inductive coupling plasma chemical vapor deposition process. The method also includes forming a silicon nitride or silicon oxynitride film on said high polymer film utilizing the inductive coupling plasma chemical vapor deposition process.

### CROSS-REFERENCE TO RELATED APPLICATIONS

This is a continuation of Patent Cooperation Treaty Application PCT/JP03/03636 filed Mar. 25, 2003, which is incorporated by reference herein in its entirety.

### FIELD OF THE INVENTION

The present invention relates to manufacturing methods and film forming apparatuses for depositing protective films for organic electro-luminescence (EL) devices.

### BACKGROUND OF THE INVENTION

Organic electro-luminescence (EL) display devices have superior characteristics such as lower power consumption, self light emission, and wider viewing angle, as compared to conventional liquid crystals and cathode ray tube CRT displays. Organic electro-luminescence (EL) display devices include an organic electro-luminescence (EL) panel formed on a glass substrate. A protective layer of high polymer film is typically formed on the organic electro-luminescence (EL) panel by a plasma polymerization or vacuum evaporation process. A silicon nitride film is typically formed on the organic electro-luminescence (EL) panel by a sputtering process. However, it has been difficult to stabilize the precise characteristics of the film quality as formed according to the conventional art. Accordingly, organic electro-luminescence (EL) displays suffer from a high probability of exhibiting problems with lifetime, device degradation and so on.

### SUMMARY OF THE INVENTION

Accordingly, embodiments of the present invention are directed toward a device and method of depositing protective films on an organic electro-luminescence panel. In one embodiment, a method for forming an electro-luminescence device includes forming a high polymer film on an electro-luminescence panel utilizing an inductive coupling plasma chemical vapor deposition process. The method also includes forming a silicon nitride or silicon oxynitride film on the high polymer film utilizing an inductive coupling plasma chemical vapor deposition process.

In another embodiment, an apparatus for plasma chemical vapor deposition (CVD) of a protective thin film on an organic electro-luminescence panel includes an inductive coupling plasma generator, a substrate holder for supporting an organic electro-luminescence substrate and a high frequency electrical power source. The high frequency electrical power source is coupled to the inductive coupling plasma generator and the substrate holder.

In another embodiment, the method and apparatus are utilized to form an organic electro-luminescence (EL) panel. The organic electro-luminescence (EL) panel includes an organic electro-luminescence substrate, a high polymer layer and a silicon nitride (SiN) or silicon oxynitride (SiON) film. The high polymer layer is formed on the organic electro-luminescence substrate using an inductive coupling plasma chemical vapor deposition process. The silicon nitride (SiN) or silicon oxynitride (SiON) film is formed on the high polymer layer using the inductive coupling plasma chemical vapor deposition process.

Embodiments of the present invention advantageously produce an organic electro-luminescence (EL) panel having a single sheet structure with substantially no permeability of moisture or oxygen because of the composite layer structure of the high polymer film and silicon nitride or silicon oxynitride film. The organic electro-luminescence (EL) panels also advantageously exhibit extremely small luminescence losses, and may thus be made applicable to fields of use such as flat TVs and cellular telephones.

### BRIEF DESCRIPTION OF THE DRAWINGS

The present invention is illustrated by way of example and not by way of limitation, in the figures of the accompanying drawings and in which like reference numerals refer to similar elements and in which:

FIG. 1 shows a block diagram of apparatus for plasma chemical vapor deposition (CVD) of a protective thin film on an organic electro-luminescence (EL) panel, in accordance with one embodiment of the invention.

FIG. 2 shows a block diagram of a film structure as formed on an organic electro-luminescence (EL) panel, in accordance with another embodiment of the invention.

### DETAILED DESCRIPTION OF THE INVENTION

Reference will now be made in detail to the embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it is understood that the present invention may be practiced without these specific details. In other instances, well-known methods, procedures, components, and circuits have not been described in detail as not to unnecessarily obscure aspects of the present invention.

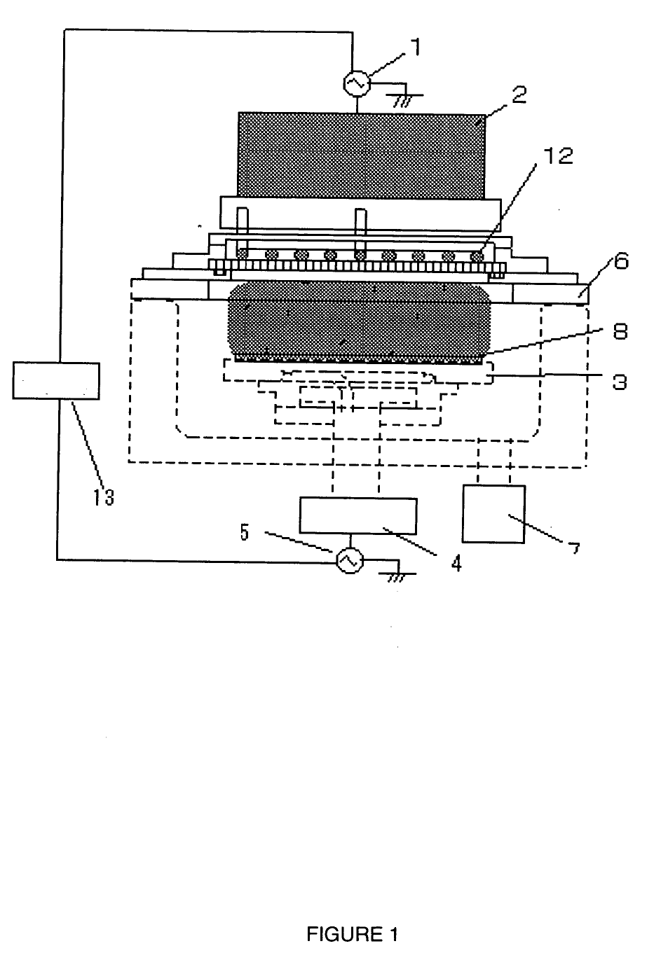

Referring to FIG. 1, a block diagram of an apparatus for plasma chemical vapor deposition (CVD) of a protective thin film on an organic electro-luminescence panel, in accordance with one embodiment of the invention, is shown. As depicted in FIG. 1, the apparatus includes a high frequency electrical power source (1) coupled to an inductive coupling plasma generator (12) by a matching circuit (2). The inductive coupling plasma generator (12) has a coil-shaped external electrode. The apparatus also includes a high frequency electrical power source for the substrate (5) coupled to a substrate holder (3) by a matching circuit for the substrate (4). The substrate holder (3) is coupled to a organic electro-luminescence substrate (8). The apparatus also includes gas inlet pump (6), a gas exhaust pump (7) and a controller (13).

In a conventional plasma chemical vapor deposition process, the normal temperature for film deposition is approximate 400° C. or more. However, in organic electro-luminescence (EL) panels the devices themselves will be destroyed unless film deposition occurs at 100° C. In embodiments of the present invention, a high-density plasma is generated by the inductive coupling type plasma generator (12). The separation between the organic electro-luminescence substrate (8) and the inductive coupling type plasma generator (12) may be approximate 200 mm or more, during deposition. In one implementation, the separation is approximate 250 mm. The pressure in the evacuated vacuum chamber may be maintained at approximate 0.1 atmospheric pressure (Pa) or less, during deposition. The organic electro-luminescence substrate (8) may be cooled to a temperature of approximate 100° C. or less, during deposition. In one implementation, the temperature of the organic electro-luminescence substrate is maintained at approximately 80° C. A high frequency electric power of approximate 13.56 MHz may be applied across the inductive coupling type plasma generator (12) and the substrate holder (3). By separating the plasma generator (12) and the organic electro-luminescence substrate (8) by at least 250 mm and cooling the substrate (8), film deposition at temperature of 100° C. or less can be achieved.

The organic electro-luminescence substrate (8) includes a plurality of cathode electrodes (9). A polymer film (10) is inductive coupling plasma chemical vapor deposited (ICP-CVD) on the cathode electrodes (9) on the upper surface of the substrate (8). The polymer film may be formed from gases including CF₄F₈ and CH₄. A silicon nitride (SiN) film or silicon oxynitride (SiON) film (11) is then ICP-CVD on the polymer film (10). The polymer film (10) and the silicon nitride or silicon oxynitride film form a protective film adapted to prevent the entry of moisture or oxygen from outside. It is also appreciated that the structure of the organic electro-luminescence (EL) devices is not changed.

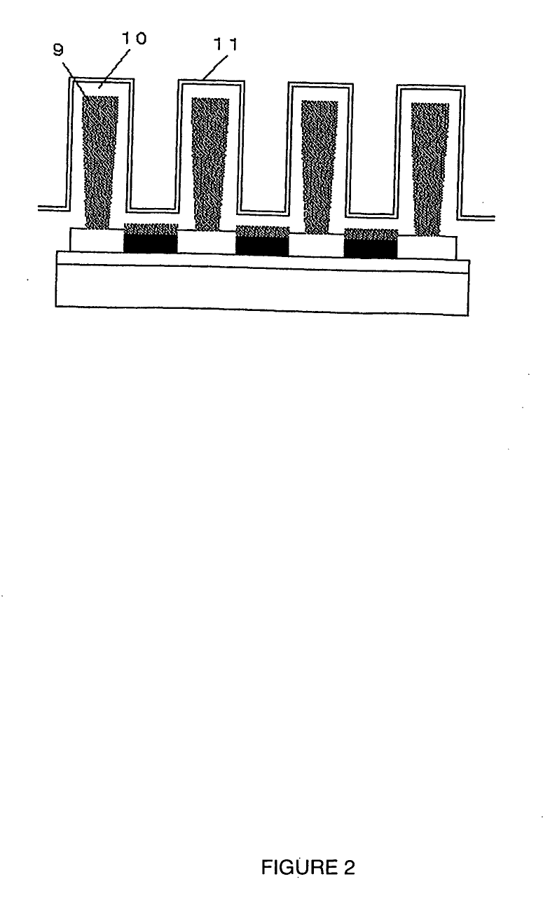

Referring now to FIG. 2, a block diagram of a film structure as formed on an organic electro-luminescence (EL) panel (8), in accordance with another embodiment of the invention, is shown. As depicted in FIG. 2, the organic electro-luminescence (EL) panel (8) includes a plurality of cathode electrodes (9), a high polymer layer (10) formed on the cathode electrode (9), and a silicon nitride (SiN) or silicon oxynitride (SiON) film (11) formed on the high polymer layer (10).

In one embodiment, the high polymer layer may be formed by an inductive coupling plasma chemical vapor deposition (ICP-CVD) process. The silicon nitride (SiN) or silicon oxynitride (SiON) film (11) may also be formed by the inductive coupling plasma chemical vapor deposition (ICP-CVD) process. The inductive coupling plasma chemical vapor deposition (ICP-CVD) process may be performed at a temperature of approximate 100° C. or less, a pressure of approximate 0.1 Pa or less, a high frequency bias voltage of approximate 13.56 MHz, with the inductive coupling plasma source separated from the organic electro-luminescence (EL) panel (8) by approximately 200 mm or more.

Inductive coupling plasma chemical vapor deposition (ICP-CVD) of the high polymer layer (10) and the silicon nitride or silicon oxynitride film (11) at temperatures bellow approximate 100° C. prevents permeability of water or oxygen (e.g., moisture) that could cause oxidation. The high polymer layer (10) and the silicon nitride or silicon oxynitride film (11) also form a protective composite film for preventing transmission of water or oxygen. In addition, plasma chemical vapor deposition (ICP-CVD) of the high polymer film before depositing the silicon nitride or silicon oxynitride film substantially reduces film stress such that the quality of the film is not damaged. The protective film effects are better than can be achieved with vacuum evaporation methods or sputtering methods utilized in the conventional protective film deposition methods. As a result, the organic electro-luminescence (EL) device itself is incorporated into a single sheet of glass, which was impossible in the conventional methods. The organic electro-luminescence (EL) devices therefore become more compact making it possible to fully harness the advantages of organic electro-luminescence (EL) devices.

In conventional organic electro-luminescence (EL) device structures light is emitted from the glass substrate side (e.g., bottom side). In organic electro-luminescence (EL) devices, in accordance with embodiments of the present invention, it is possible to emit light from the top side, which results in a substantial decrease in light losses thereby making the organic electro-luminescence (EL) panels brighter.

Accordingly, organic electro-luminescence (EL) panels may advantageously be used as a single sheet product with substantially no permeability of moisture or oxygen because of the composite layer structure of a high polymer film and silicon nitride or silicon oxynitride film. The organic electro-luminescence (EL) panels also advantageously exhibit extremely small luminescence losses, and may thus be made applicable to fields of use such as flat TVs and cellular telephones.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A plasma CVD method that is carried out using an inductively coupled CVD apparatus that forms films of high polymer, silicon oxynitride (SiON), or silicon nitride (SiN) on an organic electro-luminescence (EL) device, wherein high polymer, silicon nitride, or silicon oxynitride films are formed by introducing a processing gas into an evacuated vacuum chamber and supplying high frequency electric power to the vacuum chamber through a transmissive window of an insulator when a high frequency electric power of 13.56 MHz is applied to a coil-shaped external electrode (12) that is located above the vacuum chamber.

2. The plasma CVD method of claim 1, wherein said film formation is carried out at a temperature of at most 80° C.

3. The plasma CVD method of claim 1, wherein said film formation can be carried out with a distance of at least 200 mm between the external electrode and the substrate.

4. The plasma CVD method of claim 1, wherein said formed film may be used as a protective film in the last processing step in the organic electro-luminescence (EL) device production process.

5. The plasma CVD method of claim 1, wherein said protective film comprises a silicon oxynitride film formed on top of a film formed from gases including CF₄F₈ and CH₄.

6. A plasma CVD apparatus that is an inductively coupled CVD apparatus that forms films of high polymer, silicon oxynitride (SiON), or silicon nitride (SiN) on a device comprising an organic layer, wherein high polymer, silicon nitride, or silicon oxynitride films are formed by introducing a processing gas into an evacuated vacuum chamber and supplying high frequency electric power to the vacuum chamber through a transmissive window of an insulator when a high frequency electric power of 13.56 MHz is applied to a coil-shaped external electrode (12) that is located above the vacuum chamber.

7. The plasma CVD apparatus of claim 1, wherein said film formation is carried out at a temperature of at most 80° C.

8. The plasma CVD apparatus of claim 2, wherein said film formation can be carried out with a distance of at least 200 mm between the external electrode and the substrate.

9. The plasma CVD apparatus of claim 3, wherein said formed film may be used as a protective film in the last processing step in the organic electro-luminescence (EL) device production process.

10. The plasma CVD apparatus of claim 4, wherein said protective film comprises a silicon oxynitride film formed on top of a film formed from gases including CF₄F₈ and CH₄.

11. A method for forming an electro-luminescence device comprising:
forming a high polymer film on an organic electro-luminescence panel utilizing an inductive coupling plasma chemical vapor deposition process; and
forming a silicon nitride or silicon oxynitride film on said high polymer film utilizing an inductive coupling plasma chemical vapor deposition process.

12. The method according to claim 11, wherein:
said high polymer film is deposited at temperature of approximately 100° C. or less; and
said silicon nitride or silicon oxynitride film is deposited at temperature of approximately 100° C.

13. The method according to claim 11, wherein an inductive coupling type coil for performing said inductive coupling plasma chemical vapor deposition process is separated from said organic electro-luminescence panel by approximately 200 mm or more.

14. The method according to claim 11, wherein:
said high polymer film is deposited at a pressure of approximately 0.1 atmospheric pressure or less; and
said silicon nitride or silicon oxynitride film is deposited at pressure of approximately 0.1 atmospheric pressure or less.

15. The method according to claim 11, wherein said high polymer film is formed from gases including CF₄F₈ and CH₄.

16. The method according to claim 11, wherein a high frequency electric power is applied to an inductive coupling type coil and a substrate holder for performing said inductive coupling plasma chemical vapor deposition process.

17. The method according to claim 16, wherein said high frequency electric power has a frequency of approximately 13.56 MHz.
